(19) United States
(12) Patent Application Publication
(10) Pub. No.: US 2011/0264521 A1
(43) Pub. Date: Oct. 27, 2011

(54) Enhancing charity portal website and methods to help people support charity by making their life activities and every charity donation go farther

(76) Inventor: John Wayne STRAKA, Oakton, VA (US)

(21) Appl. No.: 13/092,879

(22) Filed: Apr. 22, 2011

Related U.S. Application Data
(60) Provisional application No. 61/326,657, filed on Apr. 22, 2010.
(60) Provisional application No. 61/358,413, filed on Jun. 25, 2010.
(60) Provisional application No. 61/363,910, filed on Jul. 13, 2010.
(60) Provisional application No. 61/421,063, filed on Dec. 8, 2010.

(51) Int. Cl. G06Q 30/00

(52) U.S. Cl. 705/14.49; 705/14.73

(57) ABSTRACT

A non-profit method and system for an enhanced charity portal website. The present invention is able to provide a plurality of charities that donors can contribute to. The present invention allows users to create activity or cause profiles in which donors can support the cause. Each activity profile is associated with a charity of choice by the user. The website of the present invention is maintained using the revenues earned through its advertisements and shopping services. All of the revenue earned minus the cost for the website maintenance is donated to the charity in addition to outside donor donations.

The current application claims a priority to the U.S. Provisional Patent application Ser. No. 61/326,657 filed on Apr. 22, 2010, the U.S. Provisional Patent application Ser. No. 61/358,413 filed on Jun. 25, 2010, the U.S. Provisional Patent application Ser. No. 61/363,910 filed on Jul. 13, 2010, and the U.S. Provisional Patent application Ser. No. 61/421,063 on Dec. 08, 2010.

### FIELD OF THE INVENTION

The present invention relates generally to a website and business method designed to implement a nonprofit business approach that seeks to inspire, promote, and enhance charitable giving. The present invention is an enhanced charity portal with thousands of charities for donors to choose form.

### BRIEF DESCRIPTION OF THE PRIOR ART

The prior art of charity portal websites includes some websites such as JustGive.org. JustGive, for example, is a nonprofit, but it is very different from my website in that JustGive acquires and processes the individual-donor funds, subsequently mailing checks to the charities. JustGive charges a transaction fee for this service of about 3%, and this is how the website earns money to pay its employees and cover its full costs. Since every dollar given to charity must first process through JustGive.org, only $0.97 of every donated dollar actually goes to the donor's selected charity.

Another form of charity website is the shopping-for-charity sites. Most of these sites, unlike mine, are oriented with the donated funds going to one particular charity or cause, with no choice for the donor (apart from the choice to shop on that site). This approach, in fact, is much like a very large number of corporate cause-related marketing campaigns today, in which a percentage of the purchase price of a product or service is donated to a particular worthwhile cause (the company selects the cause, not the consumer). In the case of most shopping-for-charity sites, a percentage of the purchase price of goods selected is donated to a particular cause chosen by the creators or charity sponsors of the website. A prominent exception is iGive.com.

iGive.com and GoodShop.com, like my website, allow the consumer to select the cause to which a donated percentage of the purchase price will be given. Unlike my website, however, iGive.com and GoodShop.com are for-profit websites. Moreover, these sites offer nothing else other than the charity shopping, and they have no aim of raising charitable donations overall, apart from the donations made by the product- or service-selling companies that have agreed to donate a percentage of the product purchase price. My website is the first to combine online direct charity giving with shopping for charity.

A key appeal of the shop-for-charity websites is that the consumer is able to trigger “free” donations from the sellers—free to the consumer—which simply result from the consumer's shopping, with no out-of-pocket costs to the consumer at all. This has an obvious appeal in lean economic times particularly, and it transfers the source of charitable funding to presumably “deeper pocket” corporate or company funds. One question that arises is whether the sellers raise purchase prices by the amount of the charitable donations, so that the consumer in effect really does pay for the donation. In most cases, however, such as iGive.com, certain pains are taken to try to ensure that this is not the case, and in fact product-price discounts are in various cases offered instead. Presumably, consumers may “police” this process as they will not pay more for a good on a shop-for-charity site than they could pay elsewhere; this may not be the case, however, as the charity donation gives the consumer an additional sense of satisfaction from purchasing the product. More importantly, perhaps, companies selling their goods on shop-for-charity sites may police themselves in the sense that they fear losing both the benefits of cause-related marketing and corporate reputation if they are found to be systematically charging consumers higher prices on these sites. The net result is unclear, but there has been no controversy raised over the product prices charged to consumers on these sites, so far as I can tell.

As noted earlier, my website will likely offer the traditional shop-for-charity service, such as that provided by iGive.com, but it is of course only one of my website's charitable-giving features. Another difference is that while my website offers thousands of charities to choose from, it focuses on charities that are screened to a degree, for example by their ratings on CharityNavigator.org (my list begins with the four-star rated charities from there). iGive.com, in contrast, allows anyone who wishes to register any charity or “cause” for donation percentages from the product sellers (consumers must still select the cause, of course). This has a distinct advantage of allowing into the process many worthwhile small charitable causes; however, it also “clogs” the very large automated list of causes, in some cases with quite questionable “causes,” making it harder for consumers to perceive or find the larger or higher-rated or more reputable national and local charities they are more familiar with.

Two established charitable-giving websites that are more diverse are GreaterGood.org and Causes.com. GreaterGood.org is a nonprofit that is owned and run by a for-profit, CharityUSA.com, and it focuses on a distinctly popular but relatively small set of charitable causes (e.g., hunger and breast cancer). This site includes a different spin and relatively narrow focus on shopping for charity (products from low income individuals in less developed nations), but it has a similar process to my website in that advertising and product revenue funds are donated to their focus charities. This site directs some of its earnings, however, to the site's selected specific charities of focus, unlike my website, which directs all of its earnings to charities selected by website users. Some of GreaterGood's overall earnings are also kept for the for-profit site owners at CharityUSA, although those relative profit earnings have not been exorbitant compared to other for-profit sites. The latter fact is not easy to learn. GreaterGood's site organization is also relatively complicated with different “sister” charity sites. The most important differences of my site from GreaterGood include the focus on achievement-based giving, the explicit enhancement of each donation to the donor's selected charity, the much broader charity selections and shopping selections and shopping for charity focus, and the broader set of activity- and giving-related services offered including social networking, all rolled into a single more transparent website and business method.

Causes.com has a broad but different approach compared to my website and does not include many of the features on my site (where included, these are not featured prominently as on my website). Causes.com is also a for-profit site, and it includes various features not on my site. The Causes website encourages site users to add or adopt a cause and recruit others to donate to their chosen cause and otherwise help promote it. The result is a large collection of causes, which again is encouraging to smaller charitable causes—but only a small subset of the total causes on the site attract a significant group of passionate supporters that donate and promote the cause. This is very different from my website, where the prominent focus is on encouraging activity/achievement-based charity donations and conventional and other donations to thousands of charities screened by their reviewer ratings, etc., and where the donations are explicitly augmented to the maximum extent possible. One similarity to the Milestones activity feature on my site is the Causes.com “birthday wish,” which allows individuals to use the milestone of their birthday to promote or seek donations to their chosen cause (e.g., in lieu of gifts).

Another recent, but prominent, entrant to this field is Jumo.com. Jumo is quite similar to Causes.com, with the added dimension that it ties into Facebook.com (Jumo was started by one of the better-known Facebook co-founders), and new registrants must already be on Facebook. Jumo has been launched primarily, in the words of one observer, “with the intent of creating a centralized space where Facebook members can connect with all of their favorite social causes and unite global do-gooders.”

Other charitable-donation and cause supporters such as the Case Foundation are actively involved with various related activities on the web, but like the above websites, none of these offer the specific distinctive features and combination of services on my website.

Some of the for-profit-owned charity websites have raised skepticism at times due to their for-profit focus and limited transparency, and this may have tended to inhibit their popularity and growth. This is actually a relatively complicated question, however, due to the tax laws, etc., which make it easier for for-profit organizations to attract capital, innovate, and market, etc. This is one reason why Google.org, for example, is a for-profit organization with a philanthropic focus. My website takes a new approach to this issue, which is aimed at achieving the benefits of a fully transparent nonprofit focus, while also having the flexibility of a for-profit organization.

My website will likely be owned by a for-profit limited liability corporation (LLC), but this will be an “open book” LLC and the first LLC (so far as I know) to report all of its specific costs and profit uses to CharityNavigator.org and any other interested party. The LLC will lease my website to the nonprofit organization that is featured on the site. Both the LLC and the nonprofit organization will be fully transparent.

As for the social networking aspect of my website, the many existing social networking websites—beginning with the largest and best known, of course, Facebook.com—have become a cultural phenomenon as well as a web business method. The unique claim of my website is its footprint and “look and feel” established by its core idea of linking widespread life activities such as sports and business to charitable giving. So, for example, whereas Facebook has evolved an approach of giving site users an option to ‘Like’ a company or other entity accessed through the site (a natural outgrowth of their original theme of social exchange and networking between friends), my site gives businesses and individuals a number of direct opportunities and incentives to “ACT”—to do something that will build upon their daily life activities—in a way that will benefit charity and themselves as well. So individuals and groups can pursue their daily objectives, such as sports team wins or business sales, and weave charitable giving into these everyday pursuits, while companies can give to charity and access naturally targeted consumers (via their life activities) with direct shopping and advertising access in a way that “feels good” for both parties. This dominant footprint theme extends to the core business model of my website—the transparent nonprofit approach—as well, which enhances its social attractiveness. The key footprint linkage between life activities and social growth—a type of maturation, if you will, from other social networking themes—is an attempt to help grow giving to charity and shopping for charity, for example, into things that are “cool,” uniquely facilitated, enhanced and enriched, and ultimately woven into the fabric of many individuals' everyday lives.

With respect to the direct linking of life goal-oriented activities and donations, the prior associations of sports with charitable giving, for example, have remained mainly the province of highly paid professional leagues and athletes. Fragmented efforts have brought this concept to various amateur athletes and teams, but such efforts have remained very much the exception rather than the rule. My website puts every team and athlete and league at every level of sports on an equal footing, thus facilitating and inspiring charitable giving linked to the performance of any team or athlete or event. The site is especially aimed at signing up all ranges of college, high school, youth and many other amateur teams and athletes and events. Any interested team coach, individual athlete, entire youth or amateur league, or event sponsor will be able to register quickly and easily through the sports-oriented website and begin inspiring and promoting charitable pledges and donations right away. The key here is that “little is much” when countless small contributions from fans and team supporters everywhere can build a better world together. (The estimated total number of athletes of all kinds, ages, and levels participating in organized sports in the U.S. alone easily exceeds 50 million.) Any college, high school, youth or other amateur team or athlete—and professional teams or athletes also—can also use the Sports Page and other features of the website to make existing charitable efforts reach farther than ever before. For example, the website can easily be used by busy professional athletes or their agents, for example, to quickly register the athlete, and pledge the athlete's charitable challenge grant in a self-pledge against their own team or individual performance, with a very wide range of charities to choose from.

The linking of businesses or organizations and charitable giving has likewise tended to remain concentrated among relatively well-heeled large corporate or similar foundations. The same is true of other types of activities where corporate charitable sponsorships are more common among larger than smaller companies. My website opens new opportunities in this respect by facilitating charitable giving to a wide range of charities based on the quantified performance of any business or organization, large or small, any large or small team, or any individual, through any performance-reported business activity. My website can be used by any business or individual but is especially aimed at signing up all ranges of mid-size to small business organizations, for example, which are estimated to exceed 27 million in the U.S. alone, and other kinds of nonprofit and other organizations, and smaller business teams, etc., which add far more. Any interested business, large or small, organization, group or individual goal-performer will be able to register quickly and easily though the website and begin inspiring and/or making charitable pledges and donations right away.

The prior art of traditional charity promotion still often involves costly solicitation methods that must siphon away some of the funds donated. In contrast, the invented website diverts no donated funds whatsoever, is completely costless to the charities being promoted and the donors, and through advertising and commission fees is expected to generate surplus funds to add to the donors' donated funds.

The previously discussed established and growing art of internet charity promotion includes a number of novel methods to link small charitable donations with: internet searches and home pages (“click to give” methods), selection of a web-offered product or service or use of a particular website, web viewing of a promotional vehicle (such as a video), web Q&A sites, online games, text messaging, joining a social-network web page (e.g., on Facebook), and so on. Several of these web-based charitable methods also donate differing amounts of advertising and affiliate-link revenues to charity. Key distinctions here are: 1) that these existing internet or technology-based charitable methods involve the direction of charitable giving based on some choice or set of choices or activity in the virtual world (online, i.e. on the web; and/or with mobile or other technological communication devices), whereas my website links charitable giving to real life goal-oriented activities, 2) 100% of advertising and commission earnings from my site go to the charities selected by site users, with giving incentives maximized, and 3) my site packages multiple new and existing web-based charitable-promotion methods into a single cohesive, easy-to-follow website with the theme of linking life activities, actions, and accomplishments to charity and working comprehensively with, rather than against, the self-interested incentives of individuals and businesses in order to help make giving to charity a greater part of enlightened self interest .

The prior art of linking staged/sponsored, and in this sense “artificial,” promotional activities to charitable giving (some of it quite well known) has remained balkanized across charities, with various charities sponsoring their own self-promoting activities, in the form of staged events. One prominent case, for example, is the “race for the cure” running/walking events, aimed at raising funds to combat breast cancer. The invented website is not aimed at competing with these kinds of existing charitable activities, but rather, at helping to facilitate, augment, and help to promote them, while lowering their promotional costs through economies of scale (fixed costs spread across a large number of such activities, with some types of internet promotion costs, for example, perhaps lowered or made more effective for individual charities). Specific staged charity events can use the invented website's infrastructure in addition to, in a link, in a wrap around, or in some cases perhaps in lieu of (to lower costs), the charity's own website infrastructure. My site will offer charity-event registration through the site or on the charity's website. A link to Charity-Plus shopping, as described elsewhere herein, can use my sight to augment any sponsored charity-event donations. The augmented donations from my website, the publicity and socialization in a giving oriented community of site users, the economies of scale, and potentials to extend or co-brand staged-event promotions to donor's non-staged life activities as well, may encourage existing charity-activity event sponsors to utilize the new invented website for their traditional staged-event charity activities.

The single most dominant theme of prior web-based approaches to promoting charitable giving, quite naturally, has been a main focus on the causes, which is of course very important. But beyond those inspired to actions by the needs, and those passionately committed to their cause(s), there is room for more, perhaps considerably more, inspired charity giving and activity. The key real life activity linkages of the invented website aim to inspire many more of a relatively untapped army of charity promoters in the many millions of amateur or higher-level athletes and coaches and the many millions of small businesses and large, business leaders and professionals, school performing groups, teachers, and other accomplishing organizations and individuals of many kinds Registrants will be able to track the success of their charity promotion—the total amount pledged based on their activities and accomplishments—through the website. They will also see direct first-hand beneficiaries and accounts of the good works done by the charitable funds donated. Case studies of donation-raising success stories and people helped will be added to the site, and recognition given for the most successful charitable promotions. Success or accomplishments in linked activities, such as a sports team or other performing group, while unpredictable, will also be definable in many different ways through different metric options (including simply the basic success of a completed activity or participation). Donors will also be able to “Donate Now” to their selected charity while designating the team, group, or individual that inspired their donation. These capabilities should help to turn some of the natural power of competition, self promotion, and striving to meet life performance goals, etc.—for example, sought-after college admissions by high school students, sought-after business goals, etc.—into the broader social benefits and personal satisfactions of greater charitable giving.

Lastly, the prior art of conventional charity donations, online and other, has also, quite naturally, been mainly focused on promoting single donations to causes, typically with limited or no donation augmentation in most cases. Some exceptions include donation matching grants from relatively well-off and passionate supporters of a cause, and donation-matching grants from profitable corporations. The invented website makes the augmentation of every charity donation simple, systematic, maximized, and guaranteed (as long as the site generates positive earnings to be distributed to the charities). It also innovates by achieving this advancement in the simplest way possible, without any need at all for my website to process any individual-donor donation funds, thereby keeping the individual-giving focus directly on the charity websites with no intermediary or “middle man” funds-handling function by my website.

### SUMMARY OF THE INVENTION

The present invention will be the first website to facilitate charity pledges and donations linked to non-virtual life goals, activities, and achievements (as well as life milestones). This will be a first online for non-staged life activities, achievements, and events not linked to a special event for charity.

It will be the first website to transparently add additional funds to all donations, which will also include conventional donations. These donations will be launched through the site or confirmed from any linked charity site. The additional donated funds will come from advertising and shopping on the site, and the nonprofit business method will transparently assure site users that all website earnings (revenue minus costs) will be distributed to the charities selected by donors using the site. The website will be the first to add 100% of its earnings to a very wide range of eligible charity donations.

The website will also be the first to offer conventional giving, giving through events, shopping for charity, comparison shopping, activity/cause social networking, and outreach features all packaged into one cohesive whole. This cohesive whole comes with the new life activity/achievement-based giving, of course. The full range of website features is centered on younger and older individuals' life activities, achievements, causes, and consumer needs.

### BRIEF DESCRIPTION OF THE DRAWINGS

FIG. 1 is an example view of the home interface of the present invention showing the plurality of activity pages displayed on the side. The activity page will be shown in the center.

FIG. 2 is a welcome page for the present invention.

FIG. 3 is a view of an explanation page for the present invention where the process is explained.

FIG. 4 is a continued view of the explanation page.

FIG. 5 is a continued view of the explanation page.

FIG. 6 is a view of an example sports page.

FIG. 7 is a view of an example business page.

FIG. 8 is a view of an example charity page.

FIG. 9 is a view of a comparison chart that shoppers may use when shopping on the website provided by the present invention.

FIG. 10 is a flow chart of the non-profit business model for the present invention.

FIG. 11 is a flow chart how the activity profiles are able to invite and inspire additional donors to donate for the cause associated with the activity profile. The activity database tracks the donations made for each activity profile.

FIG. 12 is a flow chart on how the schools page will work with the activity calendar. Teachers are able to modify the schedule, which in turn will auto-populate the activity calendar. The activities are viewed by students to follow the schedules set by teachers. Parents who support this cause are able to donate or pledge money which will directly by donate to the charity associated with the specific school page.

FIG. 13 is a flow chart showing donors being able to make conventional donations and direct donations.

### DETAIL DESCRIPTIONS OF THE INVENTION

The pages and descriptions in this section, while detailed, are illustrative of the invention claimed, and they are not intended to fully define the invention, nor are they intended to limit the scope of the invention in any way.

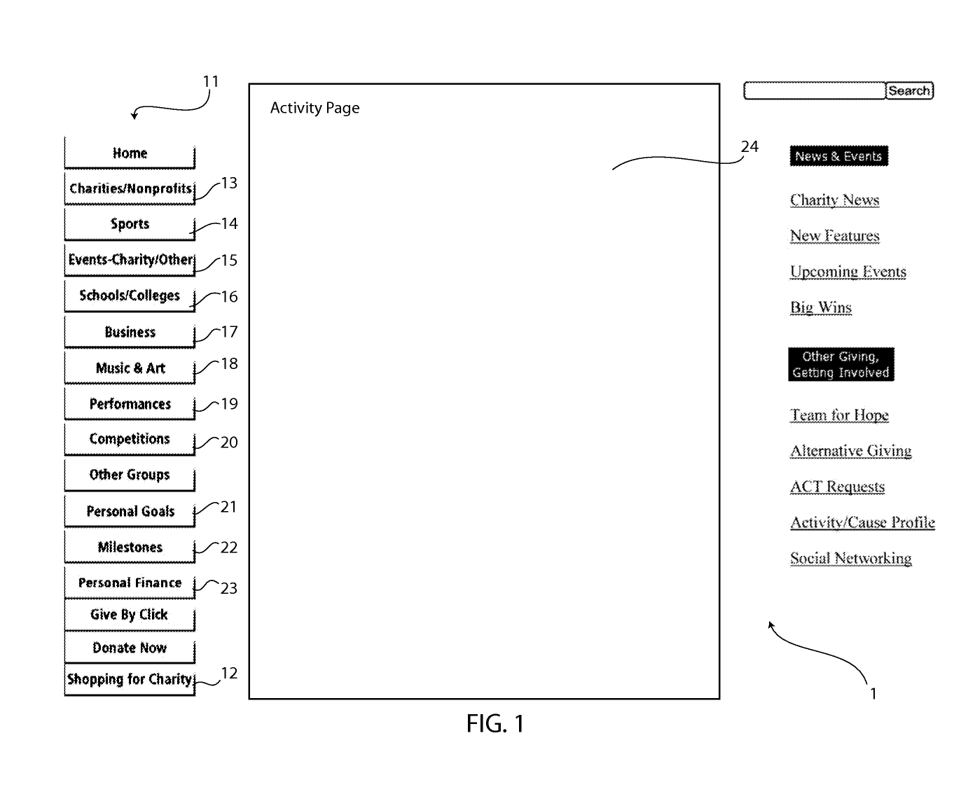

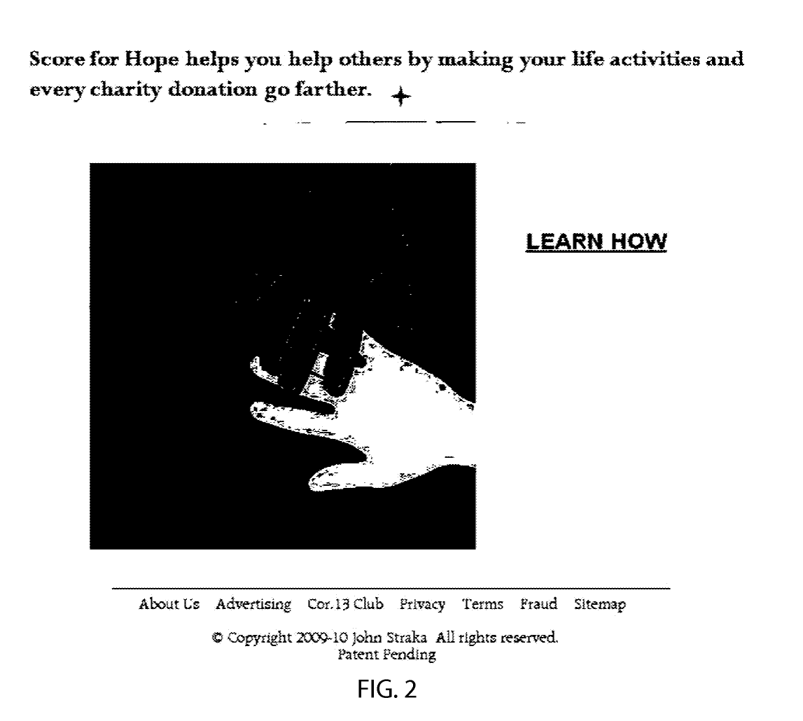

To summarize the foregoing and illustrate the footprint and “look and feel” of the website, FIG. 1 shows a home interface 1 of the present invention. In reference to FIG. 2, shown as the Home page or Welcome Page, which will greet all website visitors (within the Nav bar and page heading structures). The present invention will provide the option for donors to make pledges and donations to a plurality of charities 4. Unlike some other donation and causes websites, the present invention offers donors thousands of charities as options without limitations.

The home interface 1 includes a plurality of activity pages 11. The activity pages 11 are shown prominently in the navigation bar (to the left on each web page) as depicted in FIG. 1, giving the look and feel of the site organization, as noted above, much like the sections or pages of a traditional newspaper: Sports, Business, etc. Easy-to-use, basic website navigation, but the uniqueness of the present invention is that it is specifically used to implement the detailed services, methods, and instructions of this website in a way that is easy to understand and easy for site users to act upon. This includes the shopping for charity feature, which monetizes the website's services on each activity page, with the naturally placed details of each targeted-shopper grouping placed on each of these pages in the form of shopping categories (in shopping catalogue style).

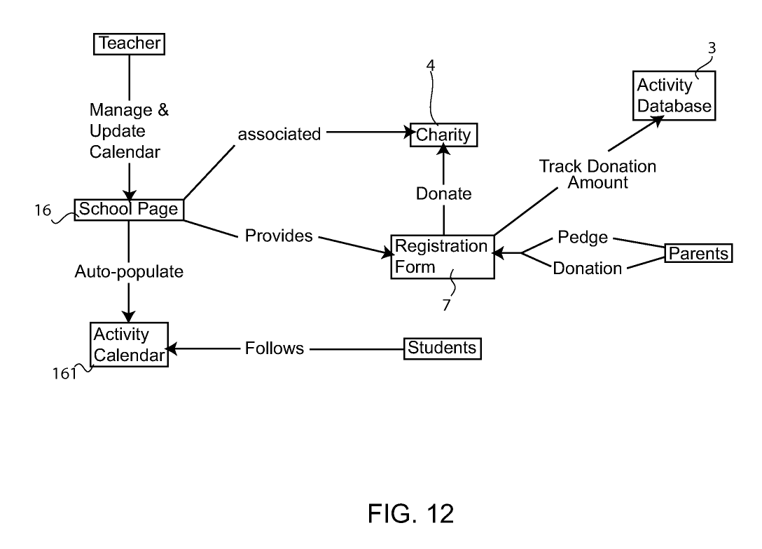

The life activity categories shown here include: nonprofits/charities, sports, events-charity/other, schools/colleges, business, music & art, performances, competitions, other groups, personal goals, milestones, personal finance, give by click, donate now, and shopping for charity. Five additional activities on the right navigation bar are specific to this website or to their use on this site: team for hope, alternative giving, ACT requests, activity/cause profile, and social networking There are also subcategories on various pages—for example, under competitions there are competing groups and individuals, and under performances there are performing groups and individuals. Other activity categories can easily be added in this type of structure if future needs or requests arise. Each of the plurality of activity pages 11 will provide a plurality of activity profile 24. Each activity profile 24 is associated with an organization and with a charity they wish to promote. The organization associated includes individuals, sports teams, business entities, financial institutes, or any other organization that wish to promote a cause for charity. The present invention provides a plurality of social networking share links 5 on the plurality of activity profile 24, as shown in FIG. 12. The organizations associated with the activity profiles 24 are able to send invitations to additional donors for additional pledges or donations registrations. The invitations can be prewritten messages of invitation or customized messages.

The home interface 1, shown in FIG. 1, uses the name Score for Hope associated with the planned final website name, www.scoreforhope.org (which will also be accessible through the draft website name, www.score-for-hope.org). This HOME page provides a clear summary of all of the major features of the website, with instructions on how to register, make a pledge, shop for charity, request a registration or a pledge, etc. All names are subject to possible later change for marketing purposes.

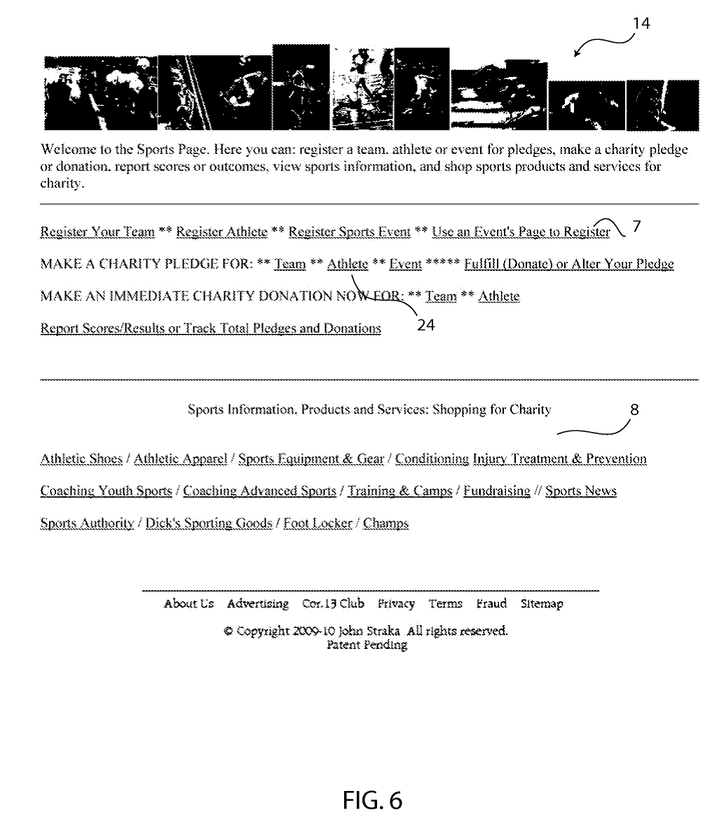

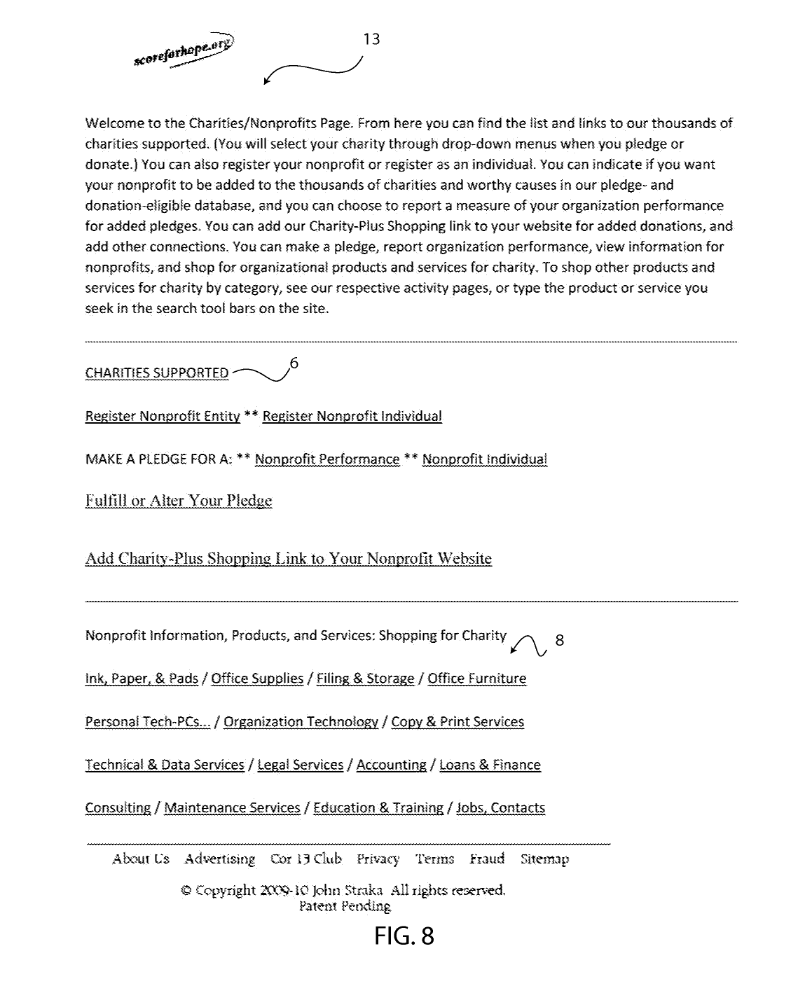

Each life-activity page is structured in a similar way, with activity-specific links to the registration and pledge page forms and custom links to information and the shopping-category pages relevant to each activity. For example, FIG. 6-8 show current drafts of the “Sports page 14,” “Business page 17” and “Charities/Nonprofits Page,” respectively. When a donor on the website of the present invention wants to find a specific activity profile 24, they are able to access the plurality of activity pages 11 to search for the activity profile 24 associated with the organizations of interest. From the plurality of activity profile 24 they are able to obtain a contribution form. They are able to use the contribution form to register and associate a charity pledge or a charity donation to a charity linked to the activity profile 24.

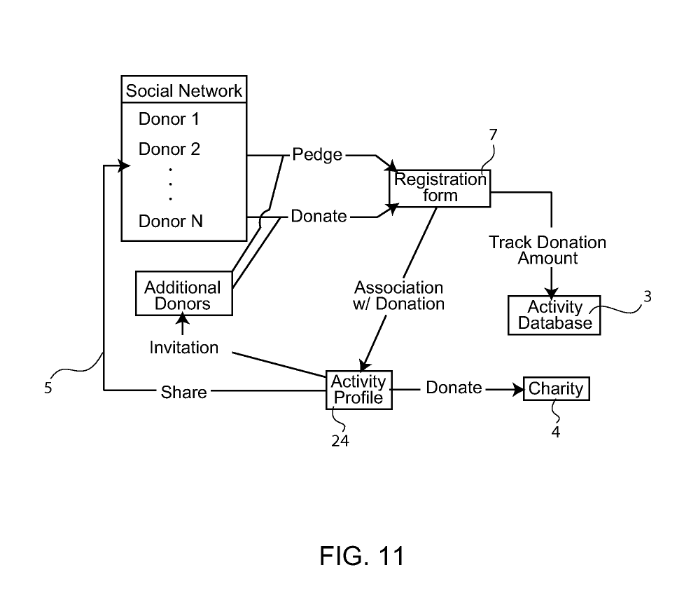

In reference to FIG. 11, each of the plurality of activity pages 11 provides a registration, which allows an organization to create additional activity profiles 24. On each activity profile 24 for the plurality of activity pages 11, a donation registration form 7 and a pledge registration form 7 is provided. The donation registration forms 7 and the pledge registration forms 7 provide donors with the means to make and associate donations with an activity profile 24 with a specific cause. When a donor makes a pledge or donation for a cause provided by an activity profile 24, the plurality of charity pledges and the plurality of plurality of donations are stored and tracked on the activity database 3. With each activity profile 24 associated with a specific charity, the amounts of each charity pledge and donation is stored, and for pledge makers, reminder emails are sent periodically, with a final notice following the end of the pledged activity.

Donations, whether immediate or fulfilling pledges, are made directly to charity websites through the charity-site links accessed via the plurality of activity pages or the Donate Now page.

As shown in FIG. 6, for example, the Sports page 14 gives any team or athlete a convenient mechanism to have coaches, fans, parents or other relatives, businesses, or other team supporters pledge and donate to charities of their choice based on the team's or athlete's goals for their season. The goals for the team or the athletes are a set condition set for their activity profile 24. For example: the total number of wins for the season, or the total points scored by the team (or athlete), or a defensive goal met, or win differentials, or a simple fixed amount for completing the team's or athlete's season—these choices are available on the registration forms. As shown, the Sports page 14 also offers specific sports-related shopping categories for: Athletic Shoes, Athletic Apparel, Sports Equipment & Gear, Conditioning, Coaching Youth Sports, Coaching Advanced Sports, Training & Camps, Injury Treatment & Prevention, Fundraising, and Sports News. The alternative team or athlete goals and the shopping categories can be easily expanded should various needs arise. Donors can make a pledge with a predetermined amount of donation for the set conditions or make a predetermined amount of donation directly for a charity.

Any team or athlete can easily register, promote the charity pledges and enhanced donations on the site, and report their score results through self-reporting to the website's Sports page 14. Alternatively, for higher-level or other teams with media reporting (professional, collegiate, scholastic) or for organized leagues with web-based reporting, automated third-party score results reporting may be used as the site develops more fully.

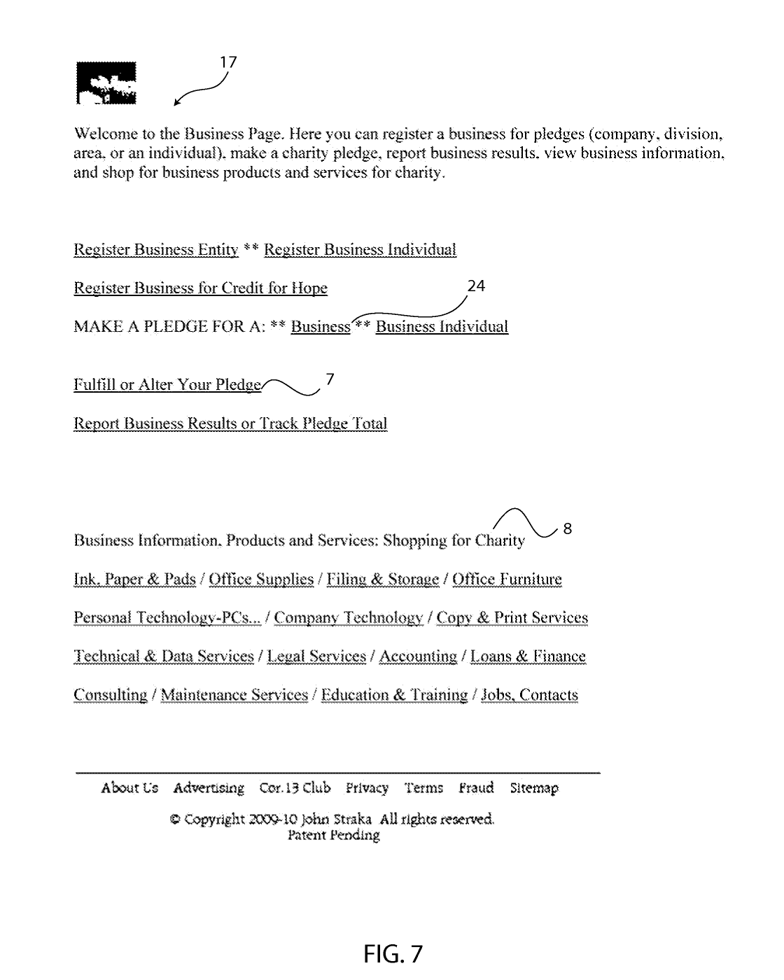

The other activity pages 11 of the website have parallel or similar structures and goals. The Business page 17, for example, shown in FIG. 7, is designed to be used by any size or type of business, business leader, or other business individual to help make and facilitate challenge grants or donations to charity associated with some reported measure of business success, such as each thousand dollars of quarterly profit, or based on the achievement of a business goal, such as a quarterly sales target. Business events or other milestones may also provide occasions for pledges and donations. The website's DONATE WITH U process of enhanced donation amounts may attract more of this kind of charity activity.

Business results, as with sports, can be self reported through the website; or alternatively, for larger businesses for example (e.g., publicly traded corporations), automated third-party business results reporting (e.g., from national or local media) may be used as the website becomes more fully developed. Another potentially important business possibility may be certain types of pledges based on self-stored business results, which could become relevant for financial institutions such as banks and credit card companies, for example (as explained below).

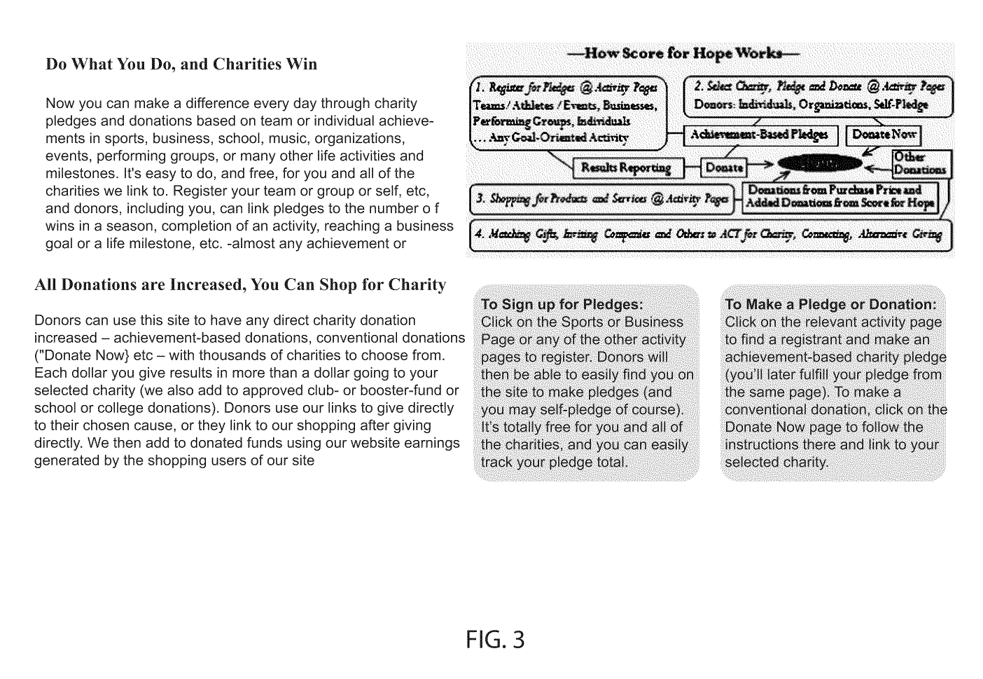

Visitors to the website's pages will select actions that will trigger targeted advertising. Most simply, the selection of a particular activity page will show that page's shopping categories, and clicking on a shopping category will bring up relevant ads targeted to individuals with an interest in that activity (e.g. sports, or business, etc.) and that particular type of product or service. To illustrate, on the current Sports page 14 shown in FIG. 3, general sports related advertising will be shown. Then with a registration, which identifies the particular sport and level, further targeting of ads will be triggered. For example, when an athlete or team registers in the sport of youth lacrosse, the sports advertising on the page will change to include specialized sellers of youth lacrosse merchandise. This benefits advertisers and shoppers, as well as charities, by raising shopper response rates with click-through sales, by helping shoppers find the greatest customized selection and most competitive prices available, and by helping Charity-Plus shoppers (described elsewhere herein) benefit their selected charity more.

The business method of the present invention makes use of a plurality of advertisements 8 to generate a portion of the revenue. The revenues, and the earnings of the website that will go to the DONATE WITH U fund, will be generated from advertising and commission rates, to begin with at least. The site will seek to become an affiliate marketing site for many advertisers. Links to advertisers' websites will naturally be provided through the separate shopping-category pages accessed from each activity page. Greater visibility and prominence of advertising is also available in each case for ads on the plurality of activity pages 11 themselves. These “prime” advertising spaces may be given to affiliate sponsors of the site and/or to the most popular ads with shoppers.

Another method whereby the present invention is able to generate revenue is through the shopping page 12 and the activity pages where a plurality of third party products and a plurality of third party services are sold. Affiliated merchants are able to sell their products or services on the shopping page 12 and each relevant activity page (in a general catalogue format). Each merchant is able to set a percentage of the sales commission to be contributed to the revenue. Shoppers are able to shop and contribute to charities at the same time on the website introduced by the present invention. The shopping page 12 provides a comparison chart 121 that allows shoppers to purchase sponsoring third party products and services. The shoppers are able to select and compare products or services on the shopping page 12 by means of the comparison chart 121. The shopping page 12 also provides information and links that inform the user about a product or service.

Historical advertising practice has shown considerable positive effects on response rates, customer growth, and loyalty from “cause-related marketing.” Businesses benefit in this way from associations with charities or other nonprofit causes. The advertising and click-through response rates of the website should benefit from this fact. In addition, unlike cause-related marketing where the charity is selected by the advertiser or seller, through this website the cause is selected by the individual shoppers/consumers themselves. This may generate enhanced positive customer and market effects for advertisers. Response rates and click-through purchase rates should be further enhanced by the DONATE WITH U process and Charity-Plus shopping, made possible by the nonprofit approach of the website. As noted earlier, the incentives will be fully aligned across advertisers on the website and the nonprofit organization that will implement the website. Advertisers want to maximize their response and click-through sales rates, and it is also the goal/mission of the website to maximize these response rates and sales since this will generate larger DONATE WITH U funds to better fulfill the nonprofit mission to boost charity donations.

Response rates, sales, and optimal ad placements can be further enhanced through statistical analysis of the response rates and purchase patterns of website visitors. The statistical analysis data is stored in an advertisement statistics database 2. Advertisers will likely conduct their own analyses of the website traffic data, and the website will also seek to become affiliated with organizations that have the resources needed for conducting these types of customized analyses around the goals of the website. The statistical analysis able to track the number of clicks on their associated plurality of advertisements 8 to calculate response rates and click-through rates for optimization.

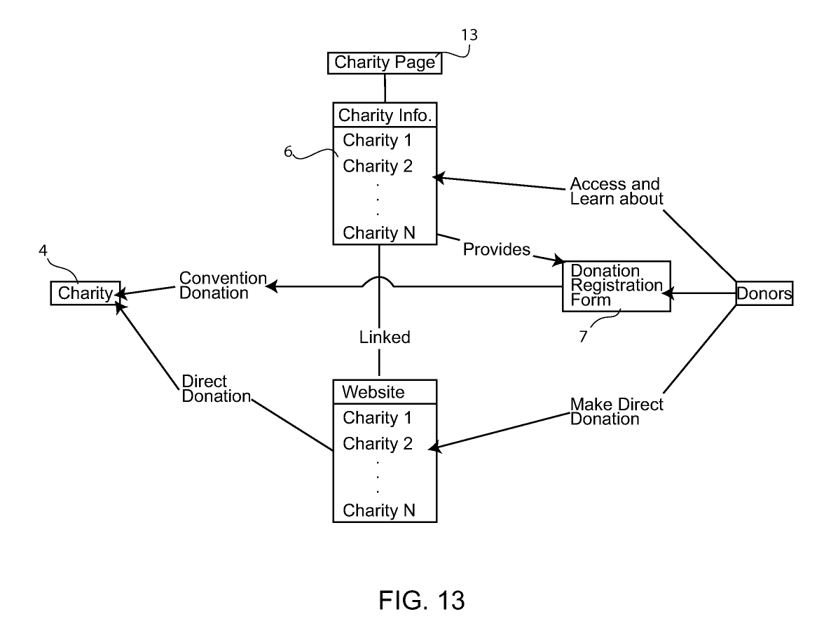

In reference to FIG. 13, the Charities/Nonprofits Page contains thousands of direct links (plurality of charity website links 6) to the websites of highly rated charities, organized alphabetically, and by charity category, starting from the plurality of charities 4 on the Charities Supported page. All individual donations launched through the site will be donated directly by the donor to their charity of choice, which is selected at pledge registration or at the Donate Now page. The charity-website link will be triggered after the donor selects Fulfill Pledge at the relevant activity page or Donate at the Donate Now page. Alternative triggering can occur on the Charities Supported page of the site (or any other relevant location) when the charity link is clicked directly. The site will not accept or process any individual charity donations, thus incurring no donation transactions costs at all. Donors may distribute their total pledge or donation across more than one charity by going to each charity website separately.

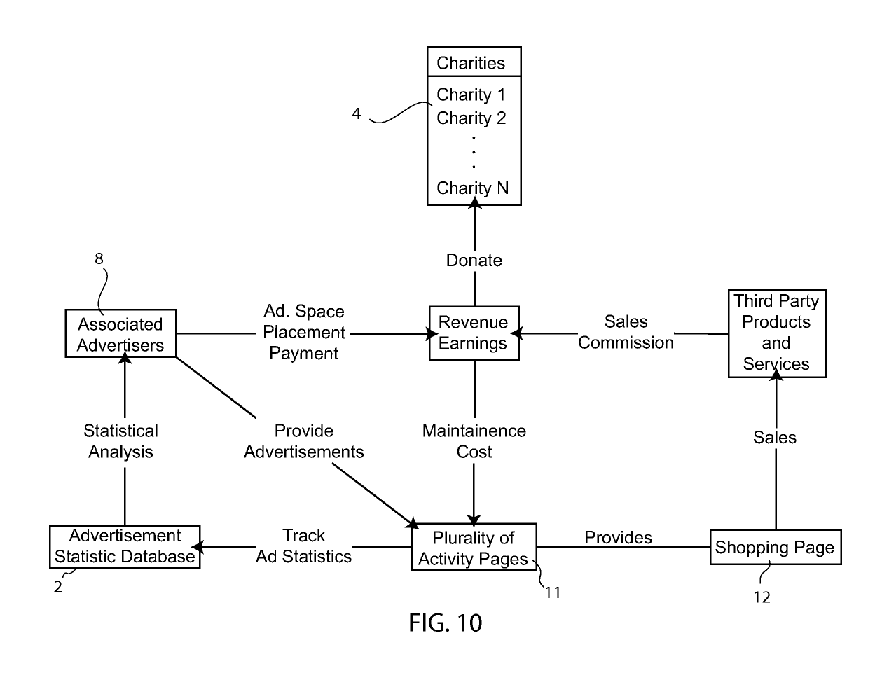

In reference to FIG. 10, the website's marketing and promotion of charitable giving will also be totally cost-free for all of the charities and for the charity pledge maker/donors, with no transaction or processing fees of any kind, although the website and the plurality of activity pages 11 will use some of the revenue earned from the advertisements and commissions to cover costs as described earlier. Since the website will not even receive or process any donors' donated funds at all, thus guaranteeing 100% direct donor donation to the charity, and since these donations will in fact be augmented through the DONATE WITH U process, the donors can of course see all this directly and with complete transparency. This should be a strong attraction for donations of all kinds through the site.

When donors select that they are proceeding to a donation (as opposed to simply seeking information), the scoreforhope website will instruct them that they must use a specific assigned email, given to them in the form <ltr><ltr>#######@scoreforhope.org, while making their donation on the charity website. This is required in order for their donation to be confirmed and augmented. The confirmation will be accomplished through the donation-confirmation or thank-you notice sent to <ltr><ltr>#######@scoreforhope.org by the charity website.

All confirmed donations will trigger the additional DONATE WITH U funds going to the donor's selected charity plus a confirmation email that will be triggered from scoreforhope.org to the donor's registered email—this will forward the donation confirmation received from the charity (for tax purposes). An email will also be triggered back to the charity, providing the registered email address of the donor to the charity (unless the donor opts out of this). In addition, the confirmation email from scoreforhope.org to the donor will also include a link that allows the donor to easily click and return to Charity-Plus shopping, which, as described elsewhere herein, maximizes the opportunity for the donor's selected charity to receive even more enhanced donation as this shopping feature is further accessed and used.

The assigned <ltr><ltr>#######@scoreforhope.org email names will not be useable for any other purpose, only for the receipt of donation confirmation emails from the charity websites. This will limit the amount of storage space needed and allow the number of <ltr><ltr>#######@scoreforhope.org email names to be sequentially ordered and essentially unlimited.

In another planned feature of the invention, basic donor information can be automatically ported from the invented website into the linked charity websites that are capable of receiving it, thus facilitating the direct fulfillment of each donor's pledged charity donation. This will be an opt-in feature offered to donors to facilitate their direct donations to their chosen charities, without re-keying.

As noted earlier, the DONATE WITH U process does not require use of the rest of the website if the donor wants to have a donation increased and knows what they are shopping for and would like this shopping to increase their donation amount. Direct donors at charity websites may be able to use a link on participating charity sites to simply access the Charity-Plus Shopping part of the site. This will require ported donor information (confirmed identification, charity name, and amount of the donation) from the charity site to the scoreforhope.org website in order for the donor's selected charity to receive the additional funds.

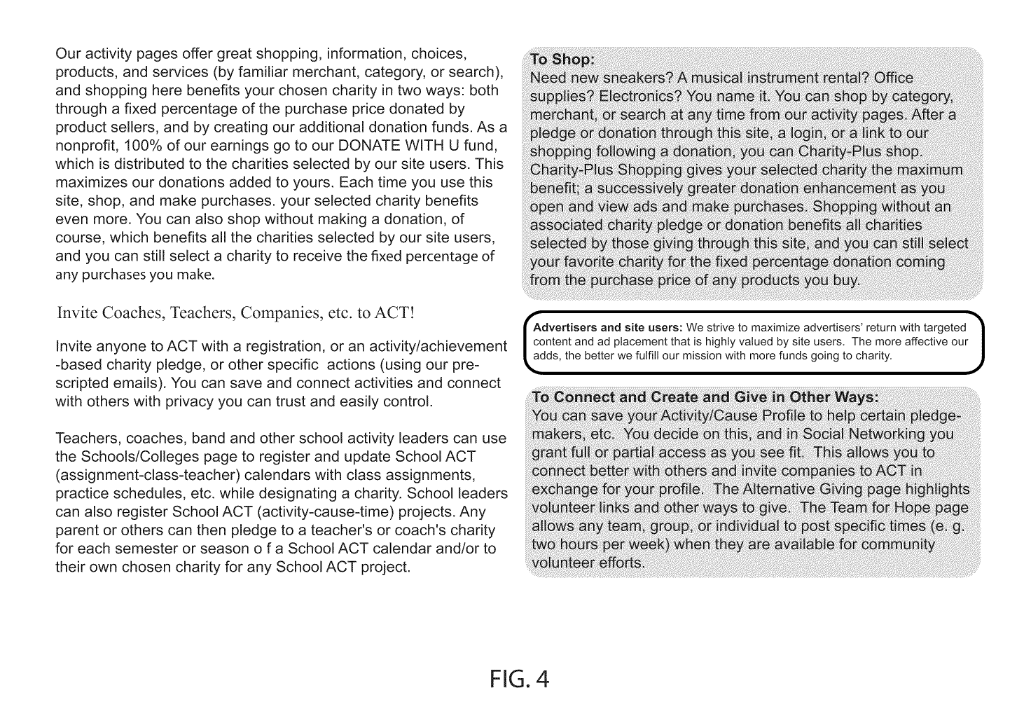

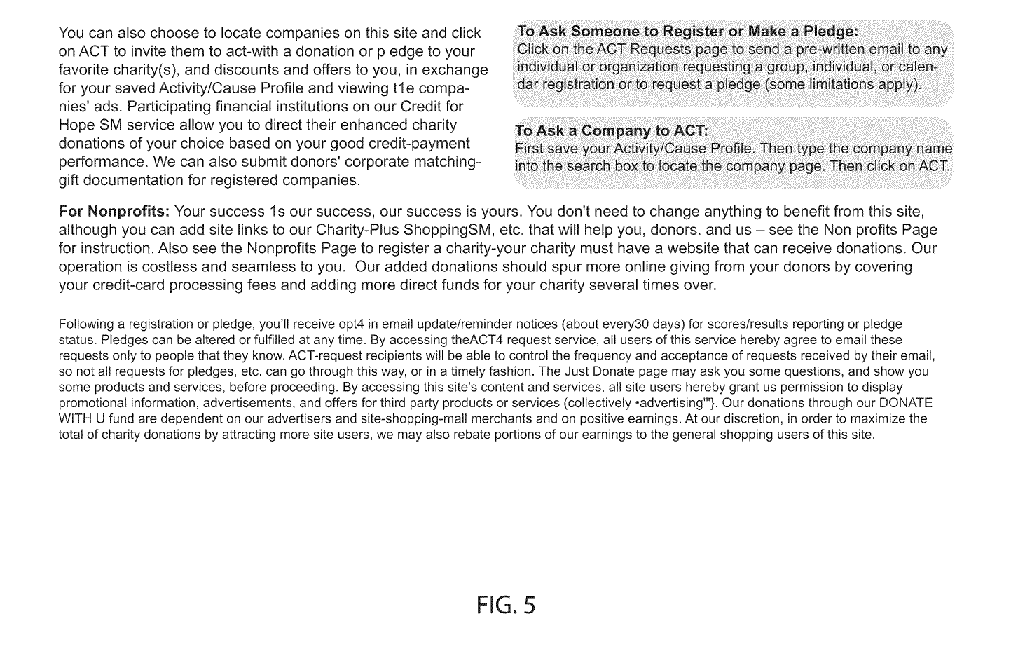

The charity page 13 and Donate Now page provide a Donate Now feature that will be used by regular site visitors for conventional charity donations (non-activity/achievement based). The process for donors on this page will typically begin with a set of questions, as disclosed in the bottom note of the Learn How page in FIG. 3-5. The question responses will allow the website to determine which targeted ads are best suited to display at the side for individuals who are using the site only for a launch of a conventional donation (to obtain the donation enhancement from scoreforhope.org) and for nothing else. For users who instead go to the Donate Now page after already visiting other pages of the site that include targeted ads, the website may be able to skip the questions, using tracking of the visiting computer IP address. The sustainability of these practices will be determined by response-rate assessments of these subtly different types of site visitors.

Another significant feature of the website is that the Charities/Nonprofits page will provide guidance and links to extensive information on the large number of charities and nonprofits included—featuring charity ratings, etc. The first screening tool used for inclusion of charity website links on the site is their charity rating from independent assessment groups.

Another significant feature of the website is that registered and participating teams, businesses, groups, and individuals will be able to track the total amount of pledged charity dollars that they have inspired, see the beneficiaries and accounts of the good works done by the donations, and receive positive feedback for their charitable promotions. Part of the website will track “big wins” or success stories (with an ability by participants to submit information), and awards and recognition will be given for the most successful charitable promotions by teams, groups, and individuals.

Another significant feature will be the flexibility of the website to accommodate new and alternative means for facilitating and enhancing life activity/achievement-based charity pledges and/or donations of any kind As an illustration, the website will be able to handle a business example, noted earlier, of self-stored performance results triggering use of the website for charitable donations. This use will be offered to the credit industry in a service called Credit for Hope. Any financial-institution creditor, large or small, may use the Business page 17 to register for a new charity donation program, in which the creditor will make a periodic charity donation, to a charity selected by each of their individual credit customers, based on the on-time full-payment credit performance of that individual customer.

Banks and credit card companies may agree to adopt this new practice using their self-stored credit performance information on their credit card customers, for example. The same approach can of course also be taken with auto loans, student loans, small business loans, etc. For the case of credit cards, this will be similar to credit card “rewards” or rebate programs, with the key difference being that the business itself is specifically targeting some of its own funds for charity, while allowing the individual consumer customer to select the charity and thereby direct the bank's donated funds on a periodic basis.

Banks and credit card companies may agree to do this through the scoreforhope.org website for the following reasons: 1) positive image from the charitable donations, 2) the increased donation amounts due to the affiliation with the nonprofit scoreforhope.org, 3) the scoreforhope website's large choice of reputable charities for the bank's customers to choose from (with authoritative giving guidance sources as well), 4) bank tax deductions from the donated funds, 5) greater incentive for the bank's credit customers to pay on time, knowing that their continued good payment performance will not only help their credit record and avoid late fees etc., but it will also trigger a periodic augmented charity donation from the bank, which they can direct, and 6) new bank-product sourcing (e.g. new credit card accounts) from some of the ads on scoreforhope.org.

In order to make this novel donation program for banks and credit customers economically viable, the scoreforhope website will probably need to become an affiliate of the financial institutions. This will make the website legally capable of receiving advertising-profile information from the banks based on the individual consumer's buying patterns, etc. This alternative source of advertising-profile information can be ported in to allow the placement of targeted ads on the periodic donation page that bank customers will link to from the bank's website. In this process, the credit customers will not need to register at all with the scoreforhope.org website. The bank's customers interact with the bank's website as usual. After the bank has informed customers through the bank website (or other bank communication) about the clean credit-performance based charity pledge, customers will be periodically directed—e.g., once a year—by the bank (through its website or other means such as emails, etc.) to click on scoreforhope.org for the purpose of directing the bank's charitable donation. Then when these customers reach the credit-customer donation web page (a page nested within the Business page 17), they will find instructions on selecting the charity and submitting the donation, along with general information and/or links on consumer credit matters and charities. The bank donor information can also be ported into the charity websites through this donation page for the credit customers. Subsequently, after the charity selection by the credit customer and the porting in of the bank donor information, this will trigger the donated funds going directly from the financial institution to the charity. Once this occurs, a record of the donation will be sent from the charity to the bank via its website (or via other communication means) for tax record purposes. This is an example of the website's flexibility centered on promoting and facilitating performance-based charity pledges and donations of any kind

In another variant of this service offered to financial institutions, credit repositories and reporting companies can bundle a very similar credit-achievement based donation process with the Credit for Hope service together with their consumer services that help individuals track and maintain their good credit records.

As a service for charity-pledge registrants, and to further facilitate pledges and donations, the website will send opt-in automatic pledge reminder/update notices to each pledge maker. Similarly, the website will send periodic score or performance-result reporting reminder notices to registered teams, businesses, groups, or individuals; these registrants will also be able to track the total charity pledges and donations inspired by their activity and achievements. Through the Sports page 14 shown in FIG. 6, for example, in a typical case the Team Coach or Manager or Score Reporter or Individual Athlete will periodically report scores or team win-loss results. Through the Business page 17 shown in FIG. 7, for example, in a typical case the Business or Manager or Team Lead or other registered Individual will periodically report sales, profits, or other business activity results. As noted earlier, higher-level or other sports teams and athletes may be able to have their performance results—wins or losses, points scored, etc.—reported into the website automatically from a third-party source (e.g., national or local media). In a similar way, larger businesses or other business/activities may be able to have their performance results—e.g., quarterly profits or sales, etc.—reported into the website automatically from a third-party source. The website will store all reported performance results for use in calculating achievement-based pledge amounts.

As shown in FIG. 6-7, for example, in links that will say “Sports News” (or Information) and “Business News” (or Information), respectively, the sports pages 14 and business pages 17, for example, will also contain links and headlines of sports and business information. This news content feature will extend to the other activity pages 11 also.

The Milestones activity page will include the ability for individuals to make charity pledges based on their own or others' life milestones, such as graduations, birthdays, etc.

The Give By Click activity page will include directions and links to existing virtual-activity promotion of charity, such as charity-benefiting internet search, virtual games, etc . This includes web navigation bars, for example, that consumers can substitute in their browsers, yielding a penny per internet search, for example, donated to charity.

The website and methods are designed to provide multiple services to groups and individuals, including:

1) offer a convenient way for all kinds of sports teams and athletes, businesses, organizations, charity and other events, performing groups, and many others to inspire, make, and track charity pledges and donations linked to their goals, activities, milestones, and achievements; these registrations, pledges, and activity/achievement-based donations will be carried out through easy-to-use activity pages 11, organized much like the sections of a traditional newspaper: the Sports page 14, the Business page 17, and so on,

2) offer a simple process for conventional charity donations (not involving an activity/achievement-based pledge), to be called “Donate Now,” on its own activity page, with these donations explicitly supplemented in exchange for the site user's view of advertising (a first combination); offer of the same process on other activity pages 11 where the immediate donation can be linked to a specific activity (e.g., a sports team),

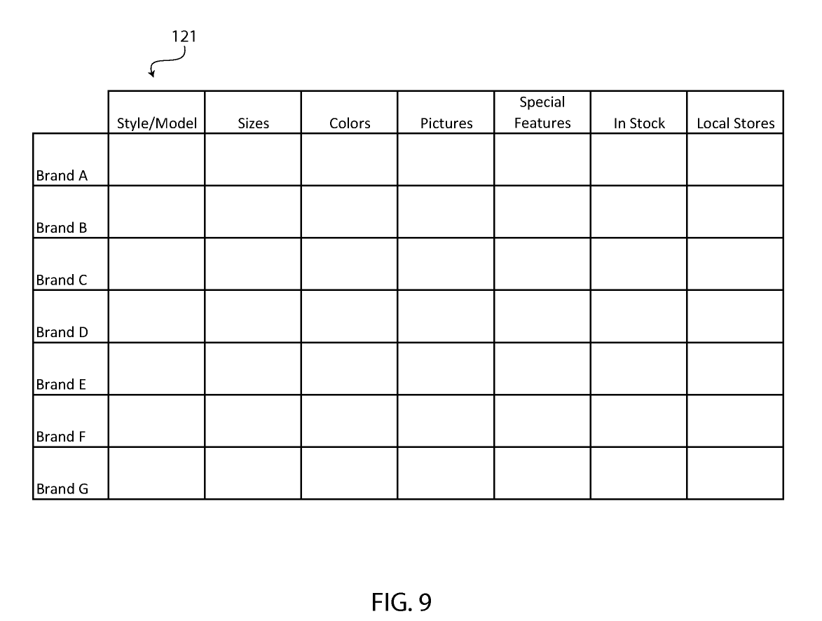

3) providing a comparison chart 121 on the shopping page 12 and offering extensive information and links, choices, and shopping for third-party products and services on the website's activity pages 11, which will seek to include special offers and discounts, as well as traditional shopping for charity (a donated percentage of the purchase price, which varies by merchant), with such shopping to include specific targeted activity-specific category pages, traditional product-search toolbars, and a new product-search convenience tool (a first) for faster internet shopping that will display and/or email search results in a single tabular comparison format (Quick Comparison Table i.e. QUIKCT, shown in FIG. 9) with requested product specifications by merchant such as Style/Model, Sizes, Colors, Pictures, Special Features, InStock, Local Stores, etc., and an opt-out option for direct-mail advertising for further information and possible discounts,

4) have donors use the website's charity links to give all of their donated funds directly to their selected charities, thus guaranteeing that 100% of donor-donated funds go directly to the donor's charity of choice (selected from thousands of alternative charities) with no processing or transaction fees of any kind,

5) allow individual donors' direct donations launched through the site to be easily confirmed via their use of a specially assigned email (generated by the website when they click on the charity link) when they donate directly at the charity website,

6) add additional donated funds (generated by the website's earnings from shopping on the site) to all donors' confirmed donations, thus allowing every dollar given through the site to result in more than a dollar going to the donor's selected charity (this comes on top of any traditional charity shopping percentages); advertising and commission revenues from shopping throughout the site will be used to cover the costs of website development, maintenance, and growth; after that, all advertising and commission earnings must be donated to the charities selected by site users (per the nonprofit mission); thus, with positive earnings generated, in all cases the website and nonprofit business approach will add to charity donations in order to help fulfill the mission and goal of enhancing and raising the volume of charity giving; this process will be called “Donate With U” or a similar identifying name; the revenue minus the maintenance costs are distributed and donated to the plurality of charities 4, as shown in FIG. 10,

7) extend the Donate-With-U process to offsite direct charity donations through a Charity-Plus Shopping link on participating charity websites,

8) offer Charity-Plus Shopping (or a similar identifying name): right after a pledge or donation, or upon returning to the site with a login, or after linking in following a donation on a participating charity website, donors will be able to Charity-Plus shop; Charity-Plus Shopping will record the shopper's actions and their chosen charity and use this information to give a donor's charity the maximum benefit: a successively greater donation enhancement as ads are opened and viewed and purchases are made,
a. anyone can also shop on the site without an associated charity pledge or donation, and this will benefit all charities selected by those giving through the site, while still allowing the shopper to select a charity for a traditional shopping-for-charity donated percentage of the sales price,

9) provide registrants an option to share information and social network. This will include options for website users to: a) save their full combined activity/cause profile information on their activities and favorite charities, etc., b) invite companies to “ACT” with a donation to the registrant's selected charity(s) and other considerations such as product information and discounts, all in exchange for the registrant's activity/cause profile and agreement to view the company's ads, and c) control their privacy by sharing with others all, or selected parts, of the “social profile” defined by their activities and causes,

10) offer a convenient way for users of the site to send pre-written form emails to request that others “ACT” with a group or individual registration or with a charity pledge,

11) offer a convenient school/activity calendar 161 service (discussed further below) on the Schools/Colleges page for students, teachers, coaches, and other activity leaders centered around a School ACT Calendar (Assignment-Class-Teacher's Calendar) that will auto-populate for students' ease of use, and facilitate School ACT Projects (Activity-Cause-Time Projects) also on the School/Colleges page. Students are able to track the plurality of student activities that are on the activity calendar 161. Parents of students are able to pledge a predetermined amount of donation to support and maintain the activity calendar 161 or make a direct contribution for the charity associated with the school page with the activity calendar 161,

12) offer a new process (discussed further herein) to financial institutions to help banks, etc. improve their image and support the positive payment habits of customers; any credit grantor, large or small, may adopt a practice of using the Business page 17 of the site to register to pledge a charitable donation that each of their credit customers will be able to direct following an on-time credit-payment performance period; likewise, credit repositories and reporting companies can bundle a similar donation process together with their consumer services that help individuals track and maintain their good credit records; this service offering will be called Credit for Hope (or a similar identifying name).

The technical programming, business and marketing aspects of the site include:

1) Charity portal; enhancing charity portal

2) Branding and servicemarking of the site
a. The branding of the website is the creation and use of the website name, logo and servicemark(s). This is, fundamentally, a marketing website, for both the charities and the advertisers. The name(s), “look and feel,” logo, and trademark(s) are all aimed to convey inspiration, trust, and transparency.

3) Targeted ads for advertisers and shoppers

4) Click-through sales response rates for advertisers

5) Affiliate relationships and sales commissions

6) Cause-related marketing for advertisers; consumer-chosen cause-related marketing

7) Nonprofit corporation

8) Statistical analysis of response rates and click-through sales to seek optimized ad placements and links
a. This features a clear alignment of incentives: advertisers want to maximize their click-through sales, of course; the nonprofit approach of the website is likewise fully incented to maximize these sales in order to generate greater advertising and commission revenues going to charity in fulfillment of the nonprofit mission.

9) Social networking options

Other detailed features of the website will include:

1) Activity/Cause Profile: Saving this and sharing it, or parts of it, with permitted parties will be separate options selected by site users. Sharing this with a pledge-maker—for example, a student-athlete's grandparent—will allow this pledge-maker to locate a single form to make multiple activity-based pledges for that individual rather than needing to go to each activity page separately. Beyond this, as noted above, users can choose to share this form, or selected parts of it, to social network through the site with friends and others interested in the same causes and activities, and with companies exchanging donations and discounts for registrants' activity/cause profiles and ad viewing.

2) Alternative Giving: This page will highlight charity volunteer links and other ways to give.

3) Team for Hope: This page will offer a simple way for teams and other groups, and individuals, to post the times of their availability (e.g. 1-2 hours per week) for volunteering in the community.

4) School ACT Calendar (Assignment-Class-Teacher's Calendar): As described above, this will be a service that allows teachers to register their class calendar on the Schools/Colleges activity page with the schedule of class assignments, etc., easily adding updated assignments throughout the semester or school year,
a. students will be able to use the website to send pre-written emails to their teachers and others requesting that they “ACT” to register their ACT Calendars, and with all of their class calendars registered, this will auto-populate and -update each student's combined assignments calendar on their Activity/Cause Profile page; students or others can also populate this calendar with their sports and other activity schedules, thus making it easier for busy high-school and other students to time manage their school work and activities.
b. coaches, band and other activity leaders, tutors, etc. can also register their team or group game and practice schedules, etc. so that these can also auto-populate and auto-update on their players'/participants' calendars, thus making it easier for coaches, etc. to communicate schedules and changes and for student-athletes and other busy activity participants to manage their time.
c. teachers, coaches, etc. can designate a selected charity when they register their ACT calendars, and parents of students in the class or activity may then make pledges to the teacher's/other leader's selected charity for each well-maintained semester, school year, or season, etc. of calendar class assignments, sports or band schedules, etc. entered in by the teacher or other team or group leader.

5) School ACT Projects (Activity-Cause-Time Projects): the facilitation of charity linked to normal school projects, which might include physical-activity assignments, such as “running cards” from recess, or any other school projects with measured achievements, whereby parents and others can use the site to pledge charity dollars in achievement-based pledges for any participating student.

6) Cor. 13 Club: This page is intended to allow new applications on the activity pages 11 to continue to grow through creative ideas and applications suggested by website users and others. The site will have the flexibility to accommodate new and alternative means and mechanisms for facilitating achievement-based or other charity pledges and donations. Organizations can suggest new applications and programs for collecting charity pledges and donations.

7) Third-party results reporting: A described earlier, for higher-level or other sports teams with media reporting (professional, collegiate, scholastic) or for organized leagues with web-based reporting, automated third-party score results reporting may be used as the site develops more fully.

8) Use of self-stored performance results: For the outlined new process offered to financial institutions, a pledged donation will be triggered through a process (described below) that uses the institution's self-stored data on customer credit performance.

9) Team or group identifier strings that are easily entered, easily identifiable by others, and one string for ease of database storage: To store large or massive amounts of general team and group information, custom identifier strings are needed or useful. On the Sports page's 14 registration form for teams, for example, this string takes the current form of “School, Youth Association, Club, Organization, City or Area_Team Name” (Examples: Bay City_Stars, Northern High School_Lions, CT Youth Association_Celtics). Similar identifying strings can be specified on other registration forms. (a first for this application)

To achieve all of the foregoing functionalities and flexibility—and several additional features and flexibilites discussed further below—requires technical programming that goes beyond basic website HTML code. The website requires PHP scripting language and MySQL for relational database programming, and also XML for ease of data sharing in the more advanced applications (such as the third-party results reporting). The website needs to maintain and manage complex automated forms, which include custom calculations, and database-driven content and links.

As such, those skilled in the art will appreciate that the conception, upon which this disclosure is based, may readily be utilized as a basis for the designing of other structures, methods and systems for carrying out the several purposes of the present invention. It is important, therefore, that any claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by any claims, nor is it intended to be limiting as to the scope of the invention in any way.

What is claimed is:

1. A system for enhancing charity portal websites comprises,
providing a home interface having a plurality of activity pages;
providing a plurality of advertisements;
providing a advertisement statistics database;
categorizing of the plurality of activity pages in activity categories including a charity page, a shopping page, a sports page, a events page, a schools page, a business page, a music arts page, a performance page, a competition page, a personal goals page, a milestones page, a personal finance page;
positioning of the plurality of advertisements on the plurality of activity pages;
providing a plurality of charity website links on the charity page and the donate now page;
providing a plurality of third party products and a plurality of third party services on the shopping page;
providing a comparison chart on the shopping page; and
providing a plurality of social networking share links on the plurality of activity pages.

2. A method for enhancing charity portal websites comprises,
providing a plurality of activity pages including a charity page, a shopping page, a sports page, an events page, a schools page, a business page, a music arts page, a performance page, a competition page, a personal goals page, a milestones page, and a personal finance page;
providing a plurality of advertisements;
providing an advertisement statistics database;
providing an activities database;
placements of the plurality of advertisements on the plurality of activity pages based on categories;
tracking of clicks on the plurality of advertisements by a statistical analysis;
calculating of response rates and click-through rates by the statistical analysis;
earning a revenue by means of the plurality of advertisements and the shopping page;
maintaining the plurality of activity pages by means of using the revenue to cover any maintenance costs; and
distributing and donating the revenue minus the maintenance cost to a plurality of charities.

3. The method for enhancing charity portal website as claimed in claim 2 comprises,
providing a plurality of activity profiles by the plurality of activities pages;
providing the a plurality of social networking share links on the plurality of activity profiles; and
providing means to share the activity profile by means of the plurality of social networking share links.

4. the method for enhancing charity portal website as claimed in claim 3 comprises,
providing a registration form for each of the plurality of activity pages;
providing means to create additional activity profiles by the registration forms;
providing the registration form on each activity profile for both pledges and donations; and
providing means to associate donations and pledges to the activity profiles by means of the registration form.

5. the method for enhancing charity portal website as claimed in claim 2 comprises,
storing of a plurality of charity pledges and a plurality of donations in the activities database, wherein the amount of each charity pledge and donation is stored and directly transferred to the plurality of charities;
associating of each of activity profile to a predetermined charity selected form the plurality of charities; and
tracking of amount of pledges and donations collected for each of the charities in the activity database.

6. the method for enhancing charity portal website as claimed in claim 2 comprises,
providing a comparison chart on the shopping page;
providing means to purchase sponsoring third party products or services; and
providing means to select and compare products or services on the shopping page by means of the comparison chart.

7. the method for enhancing charity portal website as claimed in claim 2 comprises,
providing an activity calendar by the schools page; and
providing means to automatically populate the activity calendar by the schools pages.

8. the method for enhancing charity portal website as claimed in claim 2 comprises,
providing means to send invitations for additional pledge or donation registrations, wherein the invitations are prewritten messages of invitations or customized messages; and
providing means to collect suggestions, wherein the suggestions are new applications and programs for collecting charity pledges and donations.

9. the method for enhancing charity portal website as claimed in claim 2 comprises,
providing means to make conventional donations through the charity page or donate now page;
displaying a advertisement before conventional donation is made; and
providing means to access original website of the plurality of charities by means of a plurality of charity links located on the charity page and donate now page to make direct donations.

10. A method for using the enhancing charity portal website and methods to help people support charity by making their life activities and every charity donation go farther comprises,
providing a plurality of activity pages including a charity page, a shopping page, a sports page, an events page, a schools page, a business page, a music arts page, a performance page, a competition page, a personal goals page, a milestones page, and a personal finance page;
providing a plurality of activity profiles linked to the plurality of activity profiles;
associating of the plurality of activity profiles to an organization, wherein the organizations can be individuals, sports teams, business entities, or financial institutes;
providing a plurality of advertisement; and
providing an activities database.

11. A method for using the enhancing charity portal website and methods to help people support charity by making their life activities and every charity donation go farther as claimed in claim 10 comprises,
accessing the charity page or donate now page to make conventional donations, wherein the conventional donations are indirect donations; and
accessing the websites of a plurality of charity organizations by means of a plurality of charity links on the charity page and donate now page to make direct donations.

12. A method for using the enhancing charity portal website and methods to help people support charity by making their life activities and every charity donation go farther as claimed in claim 10 comprises,
accessing the plurality of activity pages to search for the activity profile associated with the organization of interest
accessing the plurality of activity profiles to obtain a contribution form;
registering a charity pledge or a charity donation to a charity linked to the activity profile on the contribution form; and
associating the charity pledge or the charity donation to the activity profile by means of the contribution form.

13. A method for using the enhancing charity portal website and methods to help people support charity by making their life activities and every charity donation go farther as claimed in claim 11 comprises,
accessing the sports page to search for the organization of interest;
pledging a predetermined amount of donation for a set condition, wherein the set condition includes points scored in a given game by the organization of interest;
contributing a predetermined amount of donation for the charity; and
providing a predetermined goal by the organization of interest, wherein the predetermined goal includes raising a predetermined amount of money to be donated to the associated charity.

14. A method for using the enhancing charity portal website and methods to help people support charity by making their life activities and every charity donation go farther as claimed in claim 12 comprises,
accessing the business page to search for the organization of interest, wherein the organization of interest is a financial institution;
providing goals to meet, wherein goals include maintaining good credit behavior; and
reaching of goals initiating organization of interest to donating predetermined amount of money to the plurality of charities.

15. A method for using the enhancing charity portal website and methods to help people support charity by making their life activities and every charity donation go farther as claimed in claim 12 comprises,
accessing an activity calendar on the schools page;
association of the activity calendar with one of the plurality of charities;
tracking of a plurality of student activities on the activity calendar;
pledging a predetermined amount of donation to support and maintain the activity calendar;
contributing a predetermined amount of donation for the charity; and
donating of collected donations to a charity associated with the activity calendar.

16. A method for using the enhancing charity portal website and methods to help people support charity by making their life activities and every charity donation go farther as claimed in claim 10 comprises,
accessing the shopping page to purchase third party sponsored products, wherein a percentage of sale price is donated to a plurality of charity.

17. A method for using the enhancing charity portal website and methods to help people support charity by making their life activities and every charity donation go farther as claimed in claim 10 comprises,
registering an additional activity profile on the plurality of activity pages;
associating the activity profile with one of the plurality of charities;
associating the activity profile to the organization; and
providing the activity profile with a cause.

18. A method for using the enhancing charity portal website and methods to help people support charity by making their life activities and every charity donation go farther as claimed in claim 17 comprises,
providing the activity profile with a plurality of social networking options;
sharing of the activity profile through the plurality of social networking options; and
limiting information shared by the activity profile through the plurality of social networking options.
